(19) United States
(12) Patent Application Publication
(10) Pub. No.: US 2008/0251384 A1
(43) Pub. Date: Oct. 16, 2008

(54) MANUFACTURING METHOD FOR STAMPER AND MANUFACTURING METHOD FOR LIGHT GUIDE PLATE USING THE STAMPER

(75) Inventor: Ping-Feng Hwang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsinchu (TW)

(21) Appl. No.: 11/845,745

(22) Filed: Aug. 27, 2007

(30) Foreign Application Priority Data
Apr. 10, 2007 (TW) 96112423

(51) Int. Cl. C08F 2/46; C25D 1/10

(52) U.S. Cl. 205/79; 264/478; 264/496

(57) ABSTRACT

A manufacturing method for a stamper is provided. UV light cure adhesive is sprayed on a substrate and cured to form a three-dimensional pattern. Thereafter, a stamper is formed on the substrate and the three-dimensional pattern, such that the stamper has a first pattern opposite to the three-dimensional pattern. Afterwards, the stamper is separated from the substrate and the three-dimensional pattern. The stamper is disposed in a cavity of an injection molding machine to form a light guide plate. The light guide plate has a second pattern identical with the three-dimensional pattern.

### CROSS-REFERENCE TO RELATED APPLICATION

This application claims the priority benefit of Taiwan application serial no. 96112423, filed Apr. 10, 2007. All disclosure of the Taiwan application is incorporated herein by reference.

### BACKGROUND OF THE INVENTION

1. Field of the Invention

The present invention relates to a manufacturing method for a stamper and a manufacturing method for a light guide plate using the stamper. More particularly, the present invention relates to a manufacturing method using an ultraviolet (UV) light cure adhesive to form a pattern so as to manufacture a stamper and a manufacturing method for a light guide plate using the stamper.

2. Description of Related Art

Along with the development of modern video technology, LCDs have been widely used as display screens of consumable products such as mobile phones, notebook computers, personal computers, and personal digital assistants. Since LCD panels of LCDs do not have light-emitting function, backlight modules must be disposed below the LCD panels to provide surface light sources required by LCD panels, such that the LCD panel can achieve a display effect. Due to having small thickness, side-type backlight modules are widely used in portable electronic devices such as mobile phones, notebook computers, and personal digital assistants (PDAs).

In side-type backlight modules, light guide plates have a function of guiding light direction, so as to improve brightness of the display panels and control the brightness to be uniform. If an injection molding technique is adopted to fabricate light guide plates, a stamper having a pattern opposite to a three-dimensional pattern must be prepared in advance for forming an appropriate three-dimensional pattern at the back of the light guide plate for reflecting and scattering light. When the stamper is fabricated, an appropriate depressed pattern is usually fabricated on a substrate by a photolithographic etching technique. Then, an electroforming process is performed on the substrate to form a metal stamper, as illustrated in the U.S. Pat. No. 5,776,636. However, it is a waste of time to fabricate the depressed pattern by photolithographic etching, and due to a rough surface, the reflecting performance of the light is affected, and thus the brightness performance is poor.

### SUMMARY OF THE INVENTION

The present invention is directed to a manufacturing method for a stamper, capable of manufacturing a stamper in a short time.

The present invention is also directed to a manufacturing method of a light guide plate, in which a stamper of a low cost is used, thus reducing the cost of the light guide plate.

The present invention provides a manufacturing method for a stamper. First, an ultraviolet (UV) light cure adhesive is sprayed on a substrate and cured to form a three-dimensional pattern. Thereafter, a first stamper is formed on the substrate and the three-dimensional pattern, such that the first stamper has a first pattern opposite to the three-dimensional pattern. Afterwards, the first stamper is separated from the substrate and the three-dimensional pattern.

The present invention further provides a manufacturing method for a light guide plate, which includes disposing the first stamper in a cavity of an injection molding machine to form a light guide plate after finishing the above first stamper. The light guide plate has a second pattern identical with the three-dimensional pattern.

The present invention further provides a manufacturing method for a light guide plate. First, UV light cure adhesive is sprayed on a substrate and cured to form a three-dimensional pattern. Thereafter, a first stamper is formed on the substrate and the three-dimensional pattern, such that the first stamper has a first pattern opposite to the three-dimensional pattern. Afterwards, the first stamper is separated from the substrate and the three-dimensional pattern. Then, a second stamper is formed on the first stamper and the first pattern of the first stamper, such that the second stamper has a second pattern identical with the three-dimensional pattern. Then, the second stamper is separated from the first stamper and the first pattern of the first stamper. Afterwards, the second stamper is disposed in a cavity of an injection molding machine to form a light guide plate, and the light guide plate has a third pattern opposite to the three-dimensional pattern.

The present invention further provides a manufacturing method for a light guide plate, which includes after finishing the above first stamper, forming a second stamper on the first stamper and the first pattern of the first stamper, such that the second stamper has a second pattern identical with the three-dimensional pattern. Then, the second stamper is separated from the first stamper and the first pattern of the first stamper. Then, a hot-pressing is performed on a base material by the second stamper to form a light guide plate having a third pattern opposite to the three-dimensional pattern.

In view of the above, the manufacturing method for a stamper and the manufacturing method for a light guide plate are advantageous in quick, convenient, and effective processes.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1 to 6 are cross-sectional views of processes of a manufacturing method for a stamper according to an embodiment of the present invention.

FIGS. 7 and 8 are cross-sectional views of processes of using the stamper in FIG. 6 to fabricate a light guide plate.

FIGS. 9 and 10 are cross-sectional views of processes of using the stamper in FIG. 6 to fabricate another stamper.

FIGS. 11 and 12 are cross-sectional view of processes of using the stamper in FIG. 10 to fabricate a light guide plate.

### DESCRIPTION OF EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

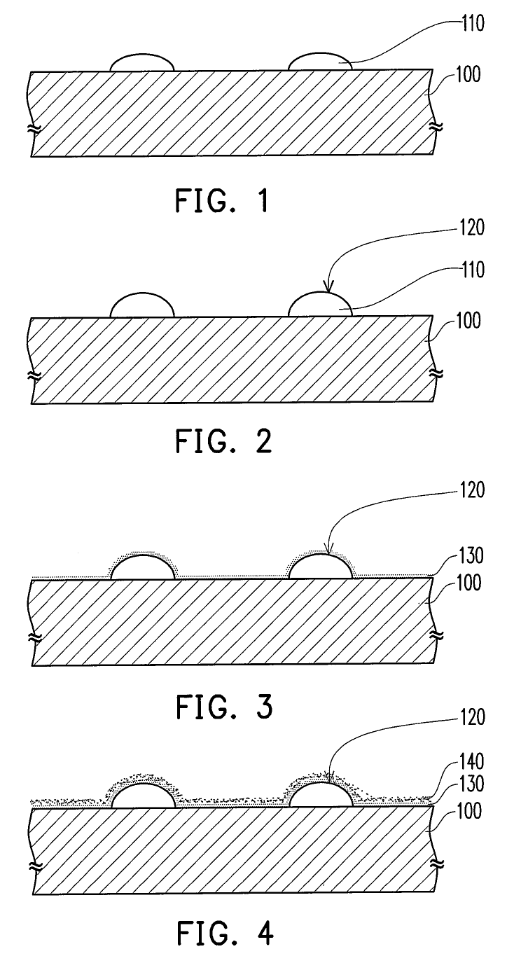

Referring to FIGS. 1 and 2, the manufacturing method for a stamper of this embodiment includes spraying an ultraviolet (UV) light cure adhesive 110 on a substrate 100 and curing the UV light cure adhesive 110 to form a three-dimensional pattern 120. The substrate 100 is a flat plate or an inclined plate with an uneven surface. Moreover, the material of the substrate includes glass, metal or other appropriate materials. Since the UV light cure adhesive 110 has a surface tension before cured, an appropriate arc surface is formed. Moreover, since the particles of the UV light cure adhesive 110 are small, a smooth surface is easily formed.

The method of forming the three-dimensional pattern 120 includes spraying the UV light cure adhesive 110 and curing the UV light cure adhesive 110 by irradiating UV light after spraying repeatedly, as shown in FIGS. 1 and 2. Or, the method of forming the three-dimensional pattern 120 includes spraying and curing the UV light cure adhesive 110 for once. Or, the method of forming the three-dimensional pattern 120 includes spraying the UV light cure adhesive 110 repeatedly and curing the UV light cure adhesive 110 for once after spraying the UV light cure adhesive 110 for several times, i.e., the frequency of curing is lower than the frequency of spraying. By spraying and curing the UV light cure adhesive 110 repeatedly, the three-dimensional pattern 120 is fabricated into any height or shape, and the three-dimensional pattern 120 is distributed on the substrate 100 uniformly. By spraying and curing the UV light cure adhesive 110, the three-dimensional pattern 120 having an optimal fineness is obtained easily.

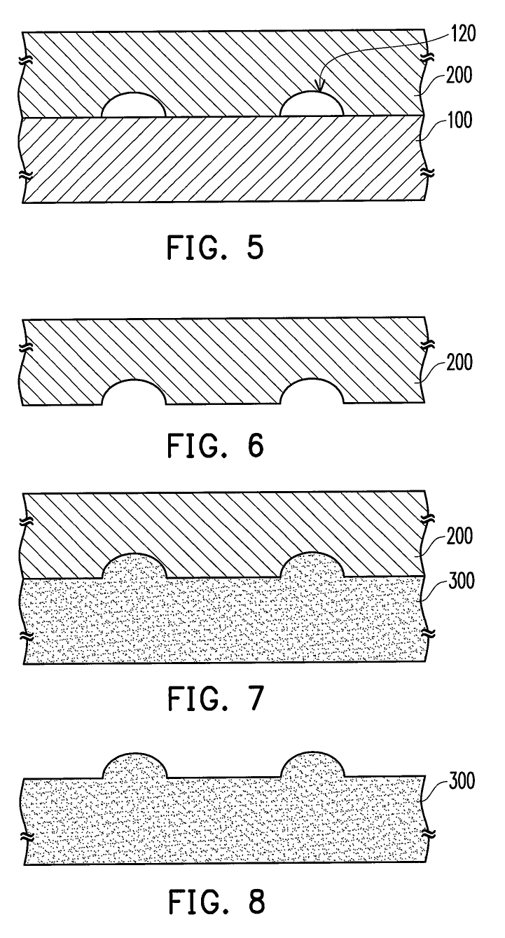

Then, referring to FIGS. 3-5, a first stamper 200 is formed on the substrate 100 and the three-dimensional pattern 120, such that the first stamper 200 has a first pattern opposite to the three-dimensional pattern 120, as shown in FIG. 5. The method of forming the first stamper 200 includes an electroforming process, which is not used to limit the present invention.

Referring to FIG. 3, if the first stamper 200 is formed by the electroforming process, a conductive layer 130 is first formed on the substrate 100 and the three-dimensional pattern 120. The conductive layer 130 may be formed by sputtering, evaporation, electrolessplating, or other suitable methods. Then, the substrate 100 is disposed in an electroforming tank, and a metal or an alloy is deposited on the substrate 100 based on an electroforming principle. When the metal or alloy deposited on the substrate 100 is accumulated to a desired thickness, the substrate 100 and the first stamper 200 formed on the substrate 100 is taken out of the electroforming tank.

Referring to FIG. 4, after the conductive layer 130 is formed and before the electroforming process is performed, a parting coating 140 is formed on the conductive layer 130, such that the subsequently formed first stamper 200 is easily separated from the substrate 100 and the three-dimensional pattern 120. When the parting coating 140 adopts a non-conductive material, the thickness of the parting coating 140 is controlled in a small range so as not to affect the efficacy of the conductive layer 130 in the electroforming process, e.g., about 1 micron.

Referring to FIGS. 5 and 6, the first stamper 200 is then separated from the substrate 100 and the three-dimensional pattern 120, and thus the manufacturing method for a stamper of this embodiment is completed.

Referring to FIG. 7, in the manufacturing method for a light guide plate according to an embodiment of the present invention, the above first stamper 200 is used to perform the injection molding to form a light guide plate 300. In specific, the first stamper 200 is disposed in a cavity (not shown) of an injection molding machine, so as to form the light guide plate 300. Finally, the light guide plate 300 shown in FIG. 8 is finished. The light guide plate 300 has a third pattern identical with the three-dimensional pattern 120 in FIG. 2. The first stamper 200 is only used to define one surface of the light guide plate 300, and the overall shape of the light guide plate 300 is determined by the cavity. Therefore, the first stamper 200 may be used to fabricate not only a flat light guide plate 300, but also a tapered light guide plate 300.

Hereinafter, a manufacturing method for a stamper and a manufacturing method for a light guide plate according to another embodiment of the present invention are illustrated with reference to the drawings.

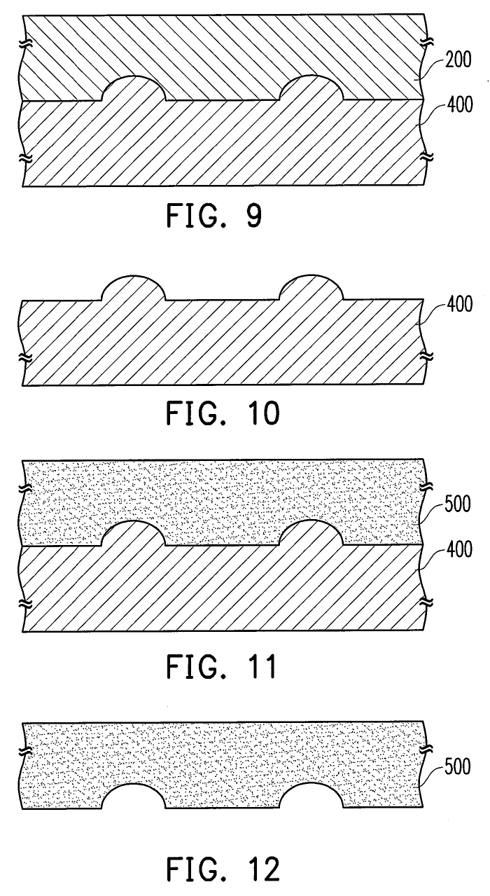

Referring to FIGS. 6 and 9, after the first stamper 200 in FIG. 6 is finished, a second stamper 400 is formed on the first stamper 200, such that the second stamper 400 has a second pattern identical with the three-dimensional pattern 120 (as shown in FIG. 2). The method of forming the second stamper 400 includes an electroforming process, which is similar to the method of forming the first stamper 200, but is not used to limit the present invention.

Referring to FIGS. 9 and 10, the second stamper 400 is then separated from the first stamper 200, and thus the manufacturing method for a stamper of this embodiment is completed.

Referring to FIG. 11, in the manufacturing method for a light guide plate according to an embodiment of the present invention, the above second stamper 400 is used to fabricate a light guide plate 500. In specific, the second stamper 400 is used to perform hot-pressing on a base material so as to form a light guide plate 500. Or, the second stamper 400 is disposed in a cavity (not shown) of an injection molding machine, so as to form the light guide plate 500. Finally, the light guide plate 500 in FIG. 12 is finished. The light guide plate 500 has a fourth pattern opposite to the three-dimensional pattern 120 (as shown in FIG. 2).

On the basis of the above, in the manufacturing method for a stamper and the manufacturing method for a light guide plate of the present invention, a UV light cure adhesive is used to form the three-dimensional pattern on the substrate, and the substrate is used to fabricate the stamper and the light guide plate. Therefore, the manufacturing method for a stamper of the present invention has a quick process, and is used to fabricate protruding or depressed three-dimensional patterns. When the stamper manufactured according to the manufacturing method for a stamper of the present invention is applied to fabricate the light guide plate, the processes of the light guide plate are accelerated and the cost is reduced. The stamper manufactured according to the manufacturing method for a stamper of the present invention may be applied to fabricate not only the light guide plate, but also other products in need of fine three-dimensional patterns.

The manufacturing method for a stamper and the manufacturing method for a light guide plate are advantageous in quick processes, a low cost, and being capable of fabricating a protruding three-dimensional pattern.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A manufacturing method for a stamper, comprising:
spraying a UV light cure adhesive on a substrate and curing to form a three-dimensional pattern;
forming a first stamper on the substrate and the three-dimensional pattern to make the first stamper have a first pattern opposite to the three-dimensional pattern; and
separating the stamper from the substrate and the three-dimensional pattern.

2. The manufacturing method for a stamper as claimed in claim 1, wherein a method of forming the three-dimensional pattern comprises spraying and curing the UV light cure adhesive repeatedly.

3. The manufacturing method for a stamper as claimed in claim 1, wherein a method of forming the first stamper comprises performing an electroforming process.

4. The manufacturing method for a stamper as claimed in claim 3, further comprising forming a conductive layer on the substrate and the three-dimensional pattern before performing the electroforming process.

5. The manufacturing method for a stamper as claimed in claim 4, further comprising forming a parting coating on the conductive layer after forming the conductive layer and before performing the electroforming process.

6. The manufacturing method for a stamper as claimed in claim 1, wherein the substrate is a flat plate or an inclined plate.

7. The manufacturing method for a stamper as claimed in claim 1, after separating the first stamper from the substrate and the three-dimensional pattern, further comprising:
forming a second stamper on the first stamper and the first pattern of the first stamper to make the second stamper have a second pattern identical with the three-dimensional pattern; and
separating the second stamper from the first stamper and the first pattern of the first stamper.

8. A manufacturing method for a light guide plate, comprising:
spraying a UV light cure adhesive on a substrate and curing to form a three-dimensional pattern;
forming a stamper on the substrate and the three-dimensional pattern to make the stamper have a first pattern opposite to the three-dimensional pattern;
separating the stamper from the substrate and the three-dimensional pattern; and
disposing the stamper in a cavity of an injection molding machine to form a light guide plate, wherein the light guide plate has a third pattern identical with the three-dimensional pattern.

9. The manufacturing method for a light guide plate as claimed in claim 8, wherein the method of forming the three-dimensional pattern comprises spraying and curing the UV light cure adhesive repeatedly.

10. The manufacturing method for a light guide plate as claimed in claim 8, wherein the method of forming the stamper comprises performing an electroforming process.

11. The manufacturing method for a light guide plate as claimed in claim 10, further comprising forming a conductive layer on the substrate and the three-dimensional pattern before performing the electroforming process.

12. The manufacturing method for a light guide plate as claimed in claim 11, further comprising forming a parting coating on the conductive layer after forming the conductive layer and before performing the electroforming process.

13. The manufacturing method for a light guide plate as claimed in claim 8, wherein the substrate is a flat plate or an inclined plate.

14. A manufacturing method for a light guide plate, comprising:
spraying a UV light cure adhesive on a substrate and curing to form a three-dimensional pattern;
forming a first stamper on the substrate and the three-dimensional pattern to make the first stamper have a first pattern opposite to the three-dimensional pattern;
separating the first stamper from the substrate and the three-dimensional pattern;
forming a second stamper on the first stamper and the first pattern of the first stamper to make the second stamper have a second pattern identical with the three-dimensional pattern;
separating the second stamper from the first stamper and the first pattern of the first stamper; and
disposing the second stamper in a cavity of an injection molding machine to form a light guide plate, wherein the light guide plate has a fourth pattern opposite to the three-dimensional pattern.

15. The manufacturing method for a light guide plate as claimed in claim 14, wherein the method of forming the three-dimensional pattern comprises spraying and curing the UV light cure adhesive repeatedly.

16. The manufacturing method for a light guide plate as claimed in claim 14, wherein the method of forming the first stamper comprises performing an electroforming process.

17. The manufacturing method for a light guide plate as claimed in claim 16, further comprising forming a conductive layer on the substrate and the three-dimensional pattern before performing the electroforming process.

18. The manufacturing method for a light guide plate as claimed in claim 17, further comprising forming a parting coating on the conductive layer after forming the conductive layer and before performing the electroforming process.

19. A manufacturing method for a light guide plate, comprising:
spraying a UV light cure adhesive on a substrate and curing to form a three-dimensional pattern;
forming a first stamper on the substrate and the three-dimensional pattern to make the first stamper have a first pattern opposite to the three-dimensional pattern;
separating the first stamper from the substrate and the three-dimensional pattern;
forming a second stamper on the first stamper and the first pattern of the first stamper to make the second stamper have a second pattern identical with the three-dimensional pattern;
separating the second stamper from the first stamper and the first pattern of the first stamper; and
performing hot-pressing on a base material by the second stamper to form a light guide plate to make the light guide plate have a fourth pattern opposite to the three-dimensional pattern.
